(19) United States
(12) Patent Application Publication
(10) Pub. No.: US 2016/0300550 A1
(43) Pub. Date: Oct. 13, 2016

(54) METHOD AND SYSTEM FOR MATCHING IMAGES AND DISPLAY DEVICES

(71) Applicant: THOMSON LICENSING, Issy-les-Moulineaux (FR)

(72) Inventors: Louis Kirk BARKER, Montara, CA (US); Saurabh MATHUR, Danville, CA (US)

(73) Assignee: Thomson Licensing

(21) Appl. No.: 15/037,767

(22) PCT Filed: Dec. 23, 2013
(86) PCT No.: PCT/US2013/077415

§ 371 Date: May 19, 2016

(51) Int. Cl. G09G 5/06; G06T 1/00

(52) U.S. Cl. CPC G09G 5/06; G06T 1/0021; G09G 2320/0666; G09G 2320/0242; G06T 2201/0065

(57) ABSTRACT

A method and system are provided for matching calibrated images with calibrated display devices, such that users can be confident of the fidelity of an image in terms of color and other image parameters when viewing a product or item represented by the image over the internet.

### TECHNICAL FIELD

The present invention generally relates to managing color image displays, and more particularly, to at least one method and system for matching calibrated images with calibrated display devices so that a user can be confident of the fidelity of the image in terms of color and other image parameters when viewing an image of a product or item over the internet.

### BACKGROUND

An increasing number of people are making purchases on the internet via several different types of user devices, including personal computers, desktops and mobile devices such as smartphones, tablets and laptops. One of the key problems with these internet-based purchases is that the displayed color of products or items can vary significantly from one user display device to another, and the displayed color may not match that of the actual product being purchased.

Internet-based shopping sites for products where color is important, such as clothes and shoes, may have a high rate of product return because the color of the product as viewed on user device did not match with the color of the actual product. As a result, such shopping sites may incur significant costs in shipping, handling and warehousing of returned products. This also reduces user confidence and leads to fewer sales.

Several solutions have been developed to improve the color accuracy of user display devices ranging from improved capabilities in displaying more colors (e.g. wide gamut displays), as well as calibration hardware and software to improve color accuracy. Typical solutions let the user perform the calibration through a multi-step process that requires the user to be skilled in several aspects of color and imaging. Such solutions are targeted towards professional users (typically photographers), and are not simple to use by a casual user who is not skilled in that domain.

In one such method, the user is presented several images with pre-defined colors and patterns. The user is then asked to tune the brightness, contrast, gamma and other technical parameters using software.

Another solution uses a color sensor that is attached to the user device to measure various technical parameters and then uses software to calibrate the device to a reference specification (http://spyder.datacolor.com/portfolio-view/spyder4pro/).

In addition, still or moving images may be captured using a set of parameters, e.g., lighting and color space, which may not match those of the user device. In such cases, the user has no way of knowing if he or she is looking at accurate colors even on a calibrated device.

Accordingly, an improved method and system are needed for providing, among other things, color fidelity of an image when, for example, purchasing a product represented by the image over the internet. As a result, the fidelity of product images can be ensured by the ecommerce vendor and minimize product returns due to wrong expectations from the consumer. Since not all web sites will offer this feature, it is important to verify that the images are coming from an authentic source with parameters that can be matched to the user's display.

### SUMMARY OF THE INVENTION

One aspect of the present principles provides a method for matching colors of an image on a website to colors on a device is disclosed. According to exemplary embodiments, the method comprises providing a device color specification and color software on the device; performing authentication of a watermark extracted from a product image on the website, wherein the product image is associated with an image color specification; and upon successful authentication, mapping colors from the image color specification to the device color specification using a predetermined function and displaying a message regarding correct color matching.

Another aspect of the present principles provides a user device, which comprises means such as a display for enabling display of a product image via a website, wherein the product image is associated with an image color specification; and means such as a processor for executing color software to authenticate a watermark extracted from the product image, and in response to successful authentication, mapping colors from the image color specification to a device color specification for the device using a predetermined function.

Yet another aspect of the present principles provide a system, which comprises means such as a camera for capturing an image; and means such as a processor for processing the captured image to generate a digital data file representing: (i) actual visual content of the captured image, (ii) an image color specification corresponding to the captured image, and (iii) a watermark for the captured image.

This summary of exemplary embodiments of the present invention is merely illustrative of the inventive concepts presented herein, and is not intended to limit the scope of the present invention in any manner.

### BRIEF DESCRIPTION OF THE DRAWINGS

The teachings of the present principles can be readily understood by considering the following detailed description in conjunction with the accompanying drawings, in which:

FIG. 1 shows a diagram of a system according to exemplary embodiments of the present invention; and

FIG. 2 shows a hardware/software and demonstrative process flow diagram according to exemplary embodiments of the present invention.

The examples illustrate preferred embodiments according to the present invention, and such examples are not to be construed as limiting the scope of the invention in any manner.

### DETAILED DESCRIPTION

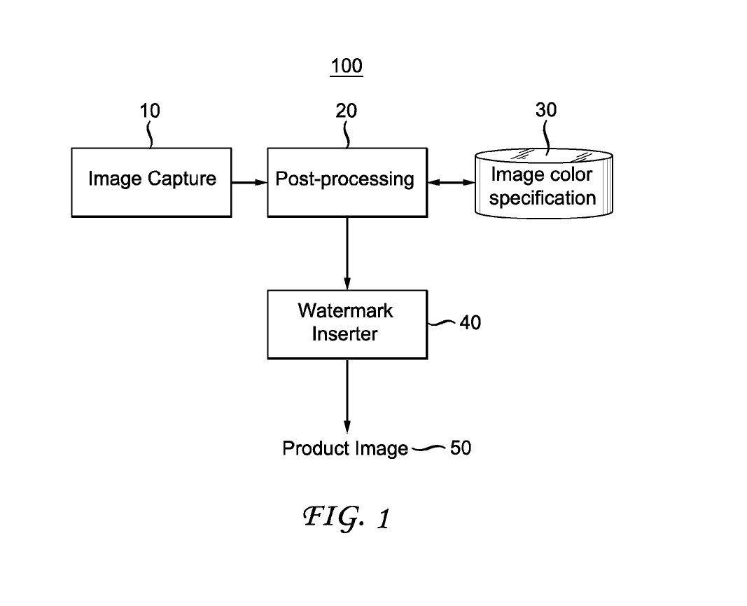

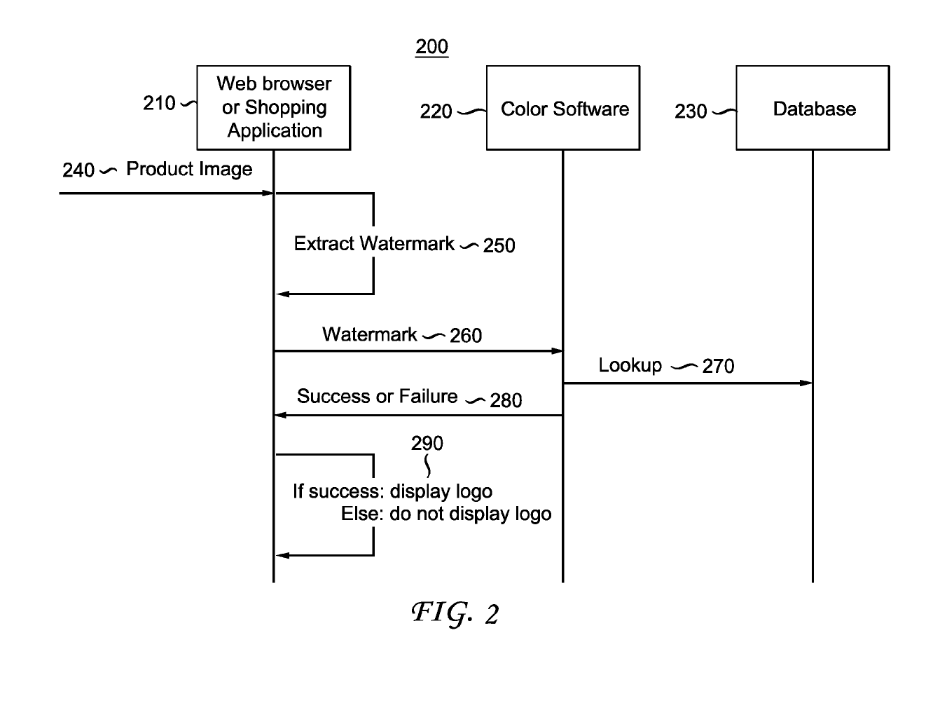

FIG. 1 shows a system 100 according to exemplary embodiments of the present principles. It is to be understood that the present principles shown and described in FIGS. 1-2 may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, embodiments of the present invention are implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

Furthermore, since some of the constituent system components and method steps depicted in the accompanying drawings are preferably implemented in software, the actual connections between the system components or the process steps may differ depending upon the manner of implementation. Given the teachings herein, one of ordinary skill in the related art will be able to contemplate these and similar implementations or configurations of the present invention.

Exemplary system 100 of FIG. 1 includes hardware and software resources and comprises an image capture block 10, a post-processing block 20, an image color specification source 30 and a watermark inserter block 40, and generates a resultant product image 50 in digital format, e.g., as one or more digital files, etc. System 100 may be implemented via one or more stand-alone digital devices in any suitable manner, including for example, through any type of wired and/or wireless communication networks.

In FIG. 1, image capture block 10 is operative or configured to capture images (e.g., via an associated camera, etc.) and produce digital data corresponding to such captured images. For example, the captured images may represent images of products intended to be sold and purchased via a digital medium, such as over the internet. As previously indicated, color fidelity in this environment may be problematic in that one or more colors of a product offered for sale by a particular website, and viewed and purchased by a consumer via a particular user display device may not match the consumer's expectations, and therefore lead to unnecessary product returns and associated costs for retailers or sellers, along with general consumer dissatisfaction. Embodiments of the present invention, including the functionality of system 100 of FIG. 1, address and solve these and/or other related issues.

Post-processing block 20 is configured or operative to process digital data, including the digital data corresponding to the captured images provided from image capture block 10. In one embodiment, in response to receiving the digital data associated with the captured image (e.g., immediately following or after a predetermined time period of the image capture event), post-processing block 20 creates an image color specification, e.g., as a separate file, corresponding to each captured image. A given image color specification includes digital data that specifies predetermined parameters including primary color (e.g., red, green, blue, etc.) values and/or other information for a corresponding captured image.

Image color specification source 30 is configured to store digital data including data for each image color specification provided from post-processing block 20. Image color specification source 30 of FIG. 1 can be embodied via various types of digital storage media that can be integrated into a user device and/or be remotely accessible over a network.

According to exemplary embodiments, each image color specification stored by image color specification source 30 can be represented as one or more associated digital files, as created by post-processing block 20 in response to the image capture event of image capture block 10. Such digital files may also include digital data representing the actual visual content of the associated captured image itself, and/or have a filename that associates the file to a particular product and/or event (e.g., particular product name, photo shoot, advertisement, among others).

Watermark inserter block 40 is configured to insert data including watermarks into the digital data (e.g., digital files described above) created by post-processing block 20 to generate and provide a resultant product image 50. For example, watermark inserter block 40 can execute any suitable watermarking algorithm, such as wavelet domain, discrete cosine transform (DCT) domain or other techniques, to insert a digital watermark. In this manner, as images of products (e.g., to be displayed and sold on the internet) are captured by image capture block 10 as per their associated image color specifications, an invisible and uniquely identifiable digital watermark is inserted into the associated image file. The advantage of using a digital watermark is that it does not significantly increase the size of the resultant product image file.

According to the present principles, the watermark inserted by watermark inserter block 40 in FIG. 1 is used as part of a color certification program that seeks to ensure, among other things, color consistency between product images displayed via specific color-certified websites and specific color-certified display devices. The watermark inserted by watermark inserter block 40 can be used for multiple purposes including, for example, authenticating a website as “color-certified” pursuant to the color certification program, as well as authenticating to a user or consumer that an image displayed via a given user display device is “color-certified” pursuant to the color certification program. Further details regarding these aspects of the invention will be provided below.

Each product image 50 generated by watermark inserter 40 in system 100 is embodied as one or more associated digital files including data representing: (i) the actual visual content of the captured image, (ii) the associated image color specification corresponding to the captured image, and (iii) the inserted and associated watermark for the captured image. Each such digital file may also have a filename that associates the file to a particular product and/or event (e.g., particular product name, photo shoot, advertisement, and so on). As will be described below, the one or more digital files representing product image 50 may be advantageously used for advertising and selling the associated product(s) over the internet in a manner that ensures that both a user display device and image of the product represent the same colors.

FIG. 2 shows a hardware/software and demonstrative process flow diagram 200 according to exemplary embodiments of the present principles. Diagram 200 shows, among other things, how data associated with a product image such as product image 50 of FIG. 1, can be used in electronic commerce such as through an internet-based shopping website or the like. As discussed above, internet-based shopping sites for products where color is important (e.g., clothes and shoes) tend to have a high rate of product return because the color of the product as viewed on the user device did not match with the color of the actual product received. As a result, such shopping sites incur significant costs in shipping, handling and warehousing of returned products. This also reduces user confidence and leads to fewer sales. The present invention solves these and/or other problems by, among other things, seeking to ensure that both the user display device and image of the product represent the same colors.

Diagram 200 comprises web browser or shopping application block 210, color software block 220, database block 230, and process flow steps 240 through 290. According to exemplary embodiments, web browser or shopping application block 210 and color software block 220 are part of, and/or provided by, a particular user device of interest (device not separately/explicitly shown in FIG. 2) having an associated display device. This user device can include, for example, personal computer, desktop, smartphone, tablet, laptop, and any other type of mobile device, among others. Database block 230 can be an integrated part of, and/or remotely located from, the particular user device. The particular user device in question-in FIG. 2 may be different from any device associated with system 100 of FIG. 1, although this is not necessarily a requirement.

According to principles of the present invention, the display device associated with the particular user device in FIG. 2 includes a device color specification comprised of predetermined data that specifies, for example, the primary color (e.g., red, green, blue, etc.) values, the tolerance (e.g., deltaE and/or other values representing differences or distances between colors, etc.), white point, gamma and/or other parameters associated with the display output characteristics (e.g., achievable “gamut”, etc.) of the display device. Furthermore, one or more lookup tables (LUTs) comprised of applicable color values are provided that bi-directionally map various image color specifications (as described above with reference to FIG. 1) to various device color specifications, and vice-versa. Such lookup tables (LUTs) may, for example, include both device-dependent color values such as RGB (red, green blue), and corresponding device-independent color values such as CIE-Lab, and so on. Data representing the device color specification of the particular user device of interest and the LUT(s) can be stored, for example, in database block 230 of FIG. 2 and/or via other storage media.

At step 240 of FIG. 2, a product image (e.g., product image 50 of FIG. 1) is displayed via web browser or shopping application block 210 of the particular user device while a consumer or user of the particular user device is visiting a particular website. The user may be browsing through products on a specific internet shopping site via a web browsing application, e.g., web browser such as Chrome, dedicated shopping site application, and so on.

The particular website may, or may not, be “color-certified” in accordance with the color certification program that seeks to provide color consistency between product images displayed via specific color-certified websites and specific color-certified display devices. A website that properly subscribes to the color certification program is a “color-certified” website. If processing resources of the particular user device determine at step 240 that the particular website being viewed is not a color-certified website, process flow advances to step 290 in FIG. 2, and there will not be any display logo for indicating compliance with the color certification program. The lack of such a logo informs the user that correct color matching has not been achieved.

At step 250 of FIG. 2, any watermark previously inserted into the product image being displayed on the website is extracted by the particular user device. According to exemplary embodiments, processing resources of the particular user device decode the displayed product image and extract any included watermark in response to user selection (e.g., for viewing) of the product image on the website. If a watermark cannot be extracted at step 250, process flow advances to step 290 in FIG. 2, and there will not be any display logo for indicating compliance with the color certification program. The lack of such a logo informs the user that correct color matching has not been achieved.

If a watermark is extracted at step 250, process flow advances to step 260 of FIG. 2, where the extracted watermark is then communicated to color software block 220 of the user device via a communication channel such as a web-socket. Color software block 220 includes color software that may be pre-loaded on the user device and/or offered as a website download, and when present on the user device, can indicate that the given user device is color-certified in accordance with the color certification program. The ability to receive the color software (e.g., via download) from a particular website can also indicate that the particular website is “color-certified” in accordance with the color certification program.

The presence of the color software of color software block 220 on the particular user device (i.e., currently loaded thereon) is detected by processing resources of the particular user device. Such detection can also be made through interaction with the particular website in question for a given transaction. When the color software of color software block 220 is detected as present, the user device may automatically switch to a “color accurate” mode that employs the advantageous color management features of the present invention. Without being in the “color accurate” mode, the color specification or settings of the user device may not be accurate or correct.

According to exemplary embodiments, color software block 220 is operative to process any extracted watermark at step 260 (e.g., via lookup to an internal memory or database of the user device and/or by communicating with a remote web server) to authenticate the watermark for purposes of determining if a particular website is color-certified and/or if a particular product image is color-certified in accordance with the color certification program. In this manner, the extracted watermark can be used for various purposes at step 260 including authenticating a website as being color-certified, as well as authenticating to a user that a displayed product image is color-certified (i.e., color-calibrated with the website) in accordance with the color certification program.

The color software of color software block 220, when executed by associated hardware processing resources of the block or user device, can perform and/or enable various digital color management functions, including the ability to authenticate or validate watermarks as described herein, access and process color look-up-tables (LUTs) to map color data values bi-directionally between various image color specifications (as described above with reference to FIG. 1) and various device color specifications, and/or perform other functions. For example, the color software may seek to maximize the achievable display gamut of a given display device (as represented by its device color specification) and adjust color values from a given image color specification (when displaying the corresponding product image) only when such color values are outside the achievable display gamut of the given display device, and hence maximizing the full color display potential of the given display device. Other types of color mapping algorithms may also be employed according to the present principles.

If the watermark extracted from the product image at step 250 has been properly authenticated at step 260, process flow advances to step 270 where the color software block 220 (with color software and associated hardware resources) retrieves and processes the previously described color lookup tables (LUTs) from database block 230. The LUTs are used to map product image colors of the displayed product (as defined by the applicable image color specification described above) to display device colors of the applicable user device (as defined by the applicable device color specification).

At step 280 of FIG. 2, a determination of “success” or “failure” is made by color software block 220 based on the foregoing steps, and the result of this determination is provided to web browser or shopping application block 210. According to exemplary embodiments, a “success” occurs at step 280 if color software block 220 is able to: (i) authenticate an extracted watermark from the product image as described above, and (ii) successfully map product image colors of the displayed product (as defined by the applicable image color specification) to display device colors of the applicable user device (as defined by the applicable device color specification). If either of these two conditions (i) and (ii) is not satisfied, a “failure” condition occurs at step 280. At step 290 of FIG. 2, a predetermined display or logo is provided via the particular user device of interest based on the determination of “success” or “failure” at step 280. In the case of a “success” determination, web browser or shopping application block 210 of the particular user device displays a predetermined display (e.g., logo, text, graphic, etc.) at step 290 to indicate that a particular product image on a website (from step 240) is color-certified in accordance with the color certification program. For example, the website may display a predetermined graphic element and/or text on the product page with the message that the color of the product is matched correctly to the user display device (color match message). A pre-defined logo can be used instead of, or in combination with, a text message for the same purpose.

Alternatively, in the case of a “failure” determination at step 280, web browser or shopping application block 210 of the particular user device will not display at step 290 the predetermined display (e.g., logo, text, graphic, etc.) that would otherwise be displayed in the case of a “success” determination at step 280. The absence of this predetermined display via the user device communicates to users that compliance with the color certification program has not been achieved. Other types of messages (e.g., “colors don't match exactly”, etc.) may also be displayed at step 290. Of course, a “failure” determination is inherently made at step 280 if the particular user device in question does not include the color software of block 220 or access to the necessary color LUTs, as described above.

As described above, the present principles provide at least one method and system for, among other things, matching calibrated, i.e., color-certified, images with calibrated display devices so that a user or consumer can be confident of the fidelity of the image in terms of color and other image parameters when viewing an image over the internet, such as when purchasing a product represented by the image.

While the forgoing is directed to various embodiments according to the present principles, other embodiments may be devised without departing from the basic scope thereof. Thus, the appropriate scope of the invention is to be determined according to the claims that follow.

1. A method for matching colors of an image on a website to colors on a device, said method comprising:
providing a device color specification and color software on said device;
performing authentication of a watermark extracted from a product image on said website, wherein said product image is associated with an image color specification; and
upon successful authentication, mapping colors from said image color specification to said device color specification using a predetermined function and displaying a message regarding correct color matching.

2. The method of claim 1, wherein said image color specification is created in response to an event of capturing said product image.

3. The method of claim 1, wherein said watermark is inserted into said product image in response to an event of capturing said product image.

4. The method of claim 1, further comprised of extracting said watermark from said product image on said website in response to user selection of said product image on said website.

5. The method of claim 1, wherein said watermark is used to authenticate said website and said product image.

6. The method of claim 1, wherein said predetermined function includes one or more look-up-tables.

7. The method of claim 1, wherein said message includes a logo indicating that said correct color matching has been achieved.

8. A device, comprising:
a display for providing a display of a product image via a website, wherein said product image is associated with an image color specification; and
a processor for executing color software to authenticate a watermark extracted from said product image, and in response to successful authentication, mapping colors from said image color specification to a device color specification for said device using a predetermined function.

9. The device of claim 8, wherein said display of said product image via said website includes a message regarding correct color matching.

10. The device of claim 9, wherein said message includes a logo indicating that said correct color matching has been achieved.

11. The device of claim 8, wherein said image color specification is created in response to an event of capturing said product image.

12. The device of claim 8, wherein said watermark is inserted into said product image in response to an event of capturing said product image.

13. The device of claim 8, wherein said watermark is extracted from said product image on said website in response to user selection of said product image on said website.

14. The device of claim 8, wherein said watermark is used to authenticate said website and said product image.

15. The device of claim 8, wherein said predetermined function includes one or more look-up-tables.

16. A system, comprising:
a camera for capturing an image; and
a processor for processing said captured image to generate a digital data file representing: (i) actual visual content of said captured image, (ii) an image color specification corresponding to said captured image, and (iii) a watermark for said captured image.

17. The system of claim 16, wherein said digital data file represents a product image on a website displayed via a web browser of a user device.

18. The system of claim 17, wherein said watermark is used to authenticate said website and said product image.

19. The system of claim 17, wherein said user device includes a device color specification and color software.

20. The system of claim 19, wherein said color software enables said user device to perform a color management function by mapping colors from said image color specification to said device color specification.
